(19) United States
(12) Patent Application Publication
(10) Pub. No.: US 2006/0209681 A1
(43) Pub. Date: Sep. 21, 2006

(54) Communication system, communication card, and communication method

(75) Inventor: Kanta Yamamoto, Kawasaki (JP)

Correspondence Address: Edward A. Pennington;Swidler Berlin LLP, Suite 300, 3000 K Street N.W., Washington, DC, 20007, US

(73) Assignee: FUJITSU LIMITED

(21) Appl. No.: 11/187,916

(22) Filed: Jul. 25, 2005

(30) Foreign Application Priority Data
Mar. 18, 2005 (JP) 2005-079420

(51) Int. Cl. H04J 3/14

(52) U.S. Cl. 370/218

(57) ABSTRACT

A communication system is provided for simply protecting a fault-caused spot and enhancing efficiency of network operation. A plurality of physical links are installed in a local span of the network. A load distribution unit virtually forms those physical links as one link aggregation and distributes load to the physical links virtually formed as the link aggregation. If fault information notified from a node at a succeeding stage is received, the load distribution unit recalculates distribution of load to normally communicable physical links. An aggregation unit aggregates data transmitted through those physical links and outputs the data according to their destinations. A fault detector detects a fault on the physical links forming the link aggregation. A fault information notice unit notifies the node at a preceding stage of the fault information.

### CROSS-REFERENCE TO RELATED APPLICATIONS

This application is based on, and claims priority to, Japanese Application No. 2005-079420, filed Mar. 18, 2005, in Japan, and which is incorporated herein by reference.

### BACKGROUND OF THE INVENTION

1. Field of the Invention

The present invention relates to a communication system, a communication card, and a communication method, and more particularly to a communication system that is configured to communicate data through a network, a communication card that is arranged to communicate data through a network, and a communication method that is arranged to communicate data through a ring network redundantly configured to have a RPR (Resilient Packet Ring).

2. Description of the Related Art

The communication networks today are likely to shift from a domestic LAN (Local Area Network) at home or in companies to a wider area network such as a network covering an overall city. For example, as a current trend, a plurality of Ethernet (Registered Trademark) LAN environments are connected through a layer 2 switch so that those LAN environments are integrated as a wide area Ethernet (10 Gigabit Ethernet).

As a core technology of information transmission of a wide area network such as the 10 Gigabit Ethernet, SONET/SDH (Synchronous Optical NETwork/Synchronous Digital Hierarchy) may be referred. The SONET/SDH prescribes an interface used for hierarchically multiplying low-speed lines and thereby speeding up the multiplied lines, for effectively multiplying various kinds of communication services. This interface is standardized and being further developed. Moreover, as a topology of the wide area network is mainly used a ring network having a plurality of nodes connected in a ring topology.

Today, the ring network based on the SONET/SDH is mainly used as a communications backbone of the wide area network mainly for a long distance transmission. However, in place of the SONET/SDH, a new remark is focused on the technology called RPR.

The RPR is a transmission technology of new MAC (Media Access Control) being standardized in IEEE 802.17. (The protocol is located in a MAC sublayer of the layer 2 like the Ethernet LAN.) This RPR realizes the ring topology without depending upon the layer 1 (for which the existing technology is used).

The RPR enables to transmit the MAC frames (RPR frames) of IEEE 802.17 onto the ring network through the use of the transmission rate series of the OC (Optical Carrier)-n of the SONET and the STM (Synchronous Transport Module)-n of the SDH or the physical layer of the layer 1 including the 10 Gigabyte Ethernet (GbE). (Concretely, the transmission of RPR over SONET/SDH or RPR over GbE are made possible.)

FIG. 12 shows a configuration of the RPR network. A network 100 includes nodes 101 to 106, all of which are connected in a ring topology through optical fibers. The information to be circulated through the ring is dropped onto a tributary station through the nodes 101 to 106 or added from the tributary station into the ring network.

Further, the double rings of the RPR are caused to flow the packets in the opposite direction to each other. In FIG. 12, the ring route F1 flows the packets clockwise and the ring route F2 flows the packets counterclockwise. The unit of information to be transmitted or distributed in the SONET/SDH transmits or distributes the information in streams, each stream being composed of plural channels including the OC and the STM, while the RPR transmits and distributes the information in packets.

Further, the RPR transmits the packets through the effect of the Spatial Reuse. Hereafter, the Spatial Reuse will be described as comparing with the UPSR (Unidirectional Path Switched Ring) that is one embodiment of the conventional SONET ring.

FIG. 13 is a conceptual view showing the operation of the UPSR. The nodes 111 to 114 connected in a ring topology compose a ring network. The UPSR transmits data of the working system in one ring as transmitting data of the protection system in the other ring in the opposite direction. If a fault takes place in the working system, the UPSR switches the system into the protection one for avoiding the fault.

For example, when data is transmitted from the node 114 to the node 111, the UPSR transmits the data from the line of the working system as transmitting the same data on the line of the protection system Pr through the nodes 113 and 112 counterclockwise. (In the normal operation, the node 111 selectively receives the data from the WEST direction.) At this time, if a line fault takes place on the line W of the working system, the UPSR switches the system into the line Pr of the protection system. This switching enables the fault to be promptly avoided. However, the protection system line Pr passing through the nodes 113 and 112 is not related with the actual communication in the normal operation. This protection system line PR thus wastes the space (transmission band). (The TDM (Time Division Multiplexing) transmission is caused to lessen usable time slots in the normal operation.)

FIG. 14 shows the Spatial Reuse. The Spatial Reuse is a function of causing data to be transmitted through the shortest route of the ring in the normal operation. When in a network 100a each of the nodes 101 to 106 communicates data with its adjacent node, as shown, the space (spans Sp1 to Sp6) is used only between the transmitting side node and the receiving side node.

For example, viewing transmission of packets from the nodes 105 to 106, the node 105 transmits the packets through the use of a path P1 of the span Sp5 only. That is, the node 105 does not transmit the packets around the ring, though the UPSR transmits the packets around one ring through the redundant system route. That is, the node 105 reuses the same transmission band as the span Sp5 for doing communications (spans Sp1, Sp2, Sp3, Sp4 and Sp6) with another node. As mentioned just before, the RPR executes the Spatial-Reuse-based transmission that flows the packets only in the necessary span. Hence, the RPR enables to effectively utilize the transmission band.

The Wrapping and the Steering in IEEE 802.17 are defined as the protection mechanisms of the RPR. These protection mechanisms are determined so that a path switching time from fault occurrence to recovery may be suppressed to be 50 msec or less like the SONET/SDH.

On the other hand, the RPR has a function of dynamically adjusting a transmission rate of each node through the effect of the FairRate (Fairness) function included therein.

FIG. 15 is an explanatory view of the FairRate Function. The FairRate function is a function of dynamically adjusting a transmission rate of each node according to the traffics of the overall ring so that each node may fairly use the band of the ring.

For example, in a network 100, when a buffer in a node 101 reaches a predetermined congestion level and the node 101 detects the congestion, the node 101 notifies a node 102 located upstream by one of how much of the band is to be secured through the use of the ring flowing the data in the opposite direction to the congested ring. In response, the node 102 arranges the using band of its own so that the band may not exceed the notified band. Further, the notified band is notified to the further nodes located in the upstream. This type of control executed in each node located in the ring makes it possible to dynamically arrange the transmission rate of each node, thereby keeping the band just to each node.

As described above, the RPR is characterized to have an effective use of the band through the effect of the Spatial Reuse, a function of fairly securing the band in each node through the effect of the FairRate algorithm, and a fault recovery capability of 50 msec or less that is the same as that of the SONET/SDH. Hence, since the RPR enables to configure so high-quality and highly reliable a network that the network may cover a variety of media, the RPR is being highly expected.

As the prior art of increasing the band of the network, the technology of increasing a transmission capacity has been proposed in which a ring node is switched so that it is coupled with another path of another network. (For example, refer to the Japanese Unexamined Patent Republication No. 2002-510160 (paragraph numbers [0014] to [0036] and FIG. 1).

The RPR ring network is standardized in IEEE 802.17 as follows. The RPR ring is configured so that each node transmits packets at the same transmission rate. For example, in FIG. 12, the ring routes F1 and F2 keep their packet transmission rates equal to each other. In FIG. 14, the spans Sp1 to Sp6 keep their packet transmission rates equal to each other.

In the actual network operation, however, uniform traffics are not always transferred through the network. For example, in a case that the data center for concentratively managing data through the server is connected in a node located on the RPR ring or a head office or a large city is located in a specific spot of the RPR ring, the traffics are concentratively transferred onto a specific node.

FIG. 16 shows the state of the network in which load is focused on a specific node. The network 100b is the network 100 shown in FIG. 12 in which a server 101a for concentrative management of data is connected with the node 101.

The packets added by all nodes 102 to 106 are transferred to the node 101 for the server 101a. In this concentrative data transfer, the optical fiber f1 of the span Sp6 between the node 101 and the node 106 is caused to span three paths, so that the band is compressed by these three paths.

In the foregoing state, since the RPR ring network is configured to keep the transmission rate equal to each path, the RPR ring network is required to equally increase the band in all spans even if the local increase of the band capacity becomes necessary.

For example, in a case that the ring is originally configured to have a transmission capacity of 100 Mbps, if a transmission capacity of 200 Mbps is required in the clockwise optical fiber f1 of the span Sp6, the RPR ring network is required to increase the band to 200 Mbps in all optical fibers of the spans Sp1 to Sp5. (In this case, the ring that flows data counterclockwise is also required to increase the band to 200 Mbps.)

The increase thus results in causing the span where 100 Mbps seemed adequate like the path P2 of the span Sp5 to have more band capacity of 200 Mbps. It means that the conventional RPR network operation is not efficient to the local increase of the band.

As for the local increase of the band as described above, the Link Aggregation may be formed. The Link Aggregation is a connecting system in which a plurality of physical links are virtually formed as one link. This system allows the span where the band capacity is locally increased to cope with the local transmission of traffics by forming the Link Aggregation. However, in a case that a fault takes place in the physical link composing the Link Aggregation, disadvantageously, the Wrapping and the Steering standardized in the RPR are not efficient in the fault protection.

FIG. 17 shows the state of the Wrapping. In the normal operation, it is assumed that a network 100c is caused to flow the information added from the node 101 counterclockwise, pass the information through the nodes 106 and 105, and drop the information in the node 104. At this time, it is also assumed that a line fault takes place in the link between the nodes 105 and 106.

In this assumption, the information added from the node 101 is turned back in the node 106 and is flown clockwise. Then, the information reaches the node 105. Next, the information is turned back again and then dropped in the node 104. That is, the Wrapping is executed to avoid a fault span if it is found and to turn the data back to the ring that flows data in the opposite direction for the purpose of avoiding the fault on the network.

FIG. 18 shows the state of the Steering. In the normal operation, it is assumed that a network 100d is caused to flow the information added from the node 101 counterclockwise, pass the information through the nodes 106 and 105, and drop the information in the node 104. At this time, it is also assumed that a line fault takes place in the link between the nodes 105 and 106.

Then, the information added from the node 101 is caused to flow clockwise and pass through the nodes 102 and 103. Then, the information reaches the node 104 in which the information is dropped. That is, the Steering is executed to cause each node to recalculate the path if a fault span is found and thereby repair the network from the fault.

The Link Aggregation is formed of a plurality of physical links. In general, hence, the signal is transmitted with the sufficiently wide transmission band in the Link Aggregation. If some faults take place in one or more of the physical links, basically, the transmission bands of the remaining physical links have so large a capacity as to cope with those faults. In such a case, if the fault protection protocols such as the Wrapping and the Steering, which are repaired to all the RPR system as stated with reference to FIGS. 17 and 18, are executed, the fault protection places heavy control load on the overall network, thereby resulting in lowering the operability.

### SUMMARY OF THE INVENTION

In view of the foregoing, it is an object of the present invention to provide a communication system which is arranged to execute a fault protection for a spot where a fault takes place between the nodes by simple means, for enhancing the efficiency of the network operation.

It is a further object of the present invention to provide a communication card which is arranged to execute a protection process for a spot where a fault takes place between the nodes by simple means, for enhancing the efficiency of the network operation.

It is another object of the present invention to provide a communication method which is arranged to execute a protection process for a spot where a fault takes place between the nodes by simple means, for enhancing the efficiency of the network operation.

In carrying out the foregoing objects, the present invention provides a communication system for communicating data through a network. The communication system is comprised of a plurality of physical links installed in a local span of the network, a first node with a first communication card having a load distributing unit inserted thereto, the load distributing unit being arranged to form a link aggregation virtually formed of a plurality of physical links installed in a local span of said network, execute a load distribution, output data to the physical links, if fault information notified from a succeeding node is received, execute the calculation of distributing the load again with respect to one or more normally communicable physical links for distributing the load, and a second node with a second communication card having an aggregation unit, a fault detecting unit and a fault information notifying unit mounted therein, the collecting unit being executed to collect data transmitted through the plurality of physical links and then output the collected data to destinations, the fault detecting unit being executed to detect a fault on the physical links composing the link aggregation and generate the fault information, and the fault information notifying unit being executed to notify an earlier node of the fault information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows a conceptual view of a communication system;

FIG. 2 shows an LA configuration corresponding with local increase of a band on a RPR ring network;

FIG. 3 shows a protocol stack;

FIG. 4 shows an LA configuration based on a ring route in one direction;

FIG. 5 shows an operating state of an LA protection process;

FIG. 6 shows an operating state of an LA protection process;

FIG. 7 shows an operating state of an LA protection process;

FIG. 8 shows an operating state of an LA protection process;

FIG. 9 shows an operating state of an LA protection process;

FIG. 10 shows a functional arrangement of a card corresponding with LA over RPR;

FIG. 11 is an explanatory view showing an operation of an LA protection process of a card corresponding with LA over RPR;

FIG. 12 shows a configuration of a RPR network;

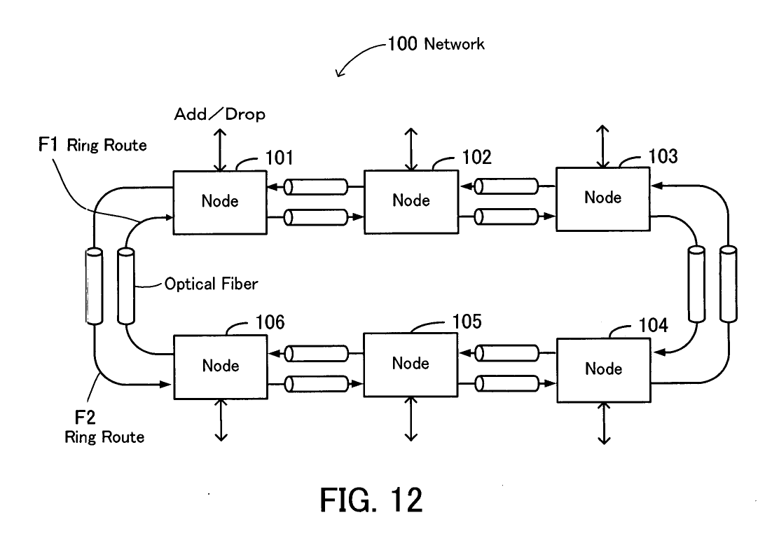

FIG. 13 is a conceptual view showing an operation of a UPSR;

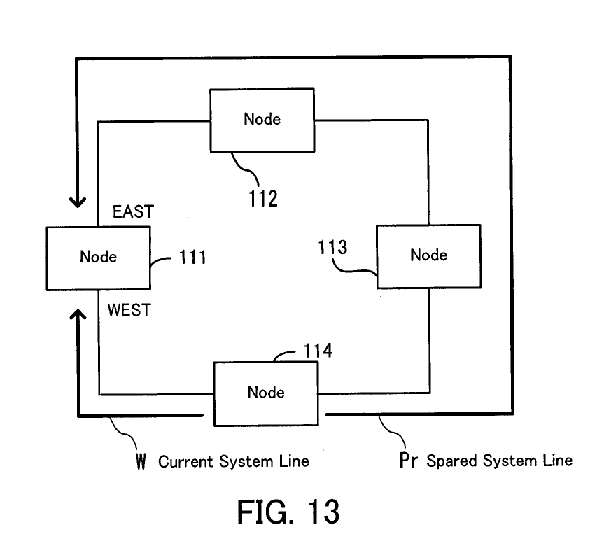

FIG. 14 shows a Spatial Reuse function.

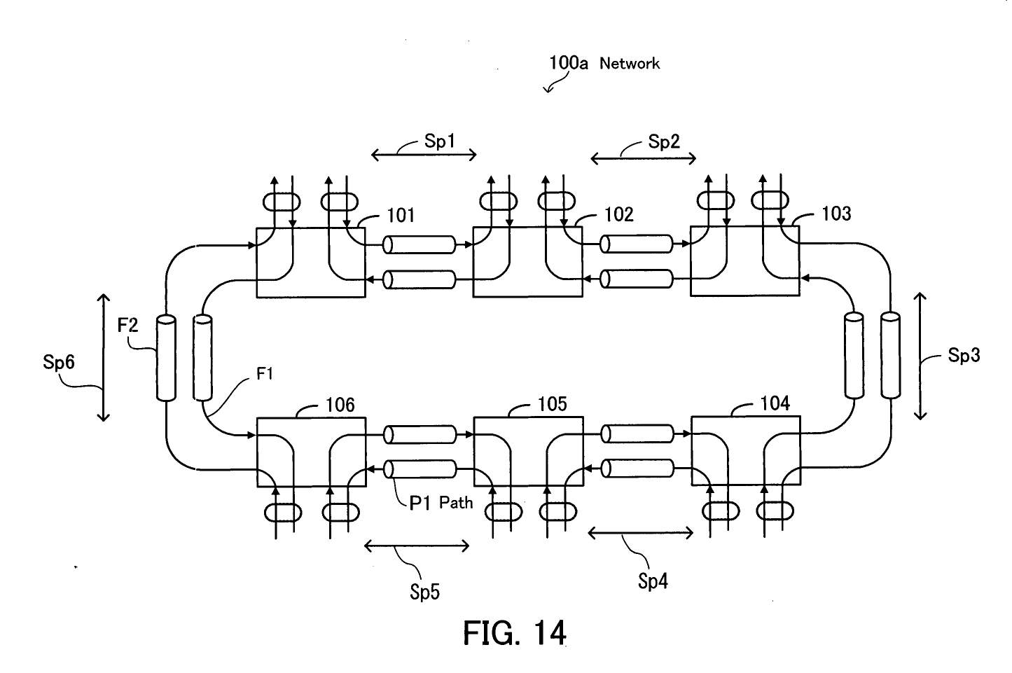

FIG. 15 is an explanatory view showing a FairRate function;

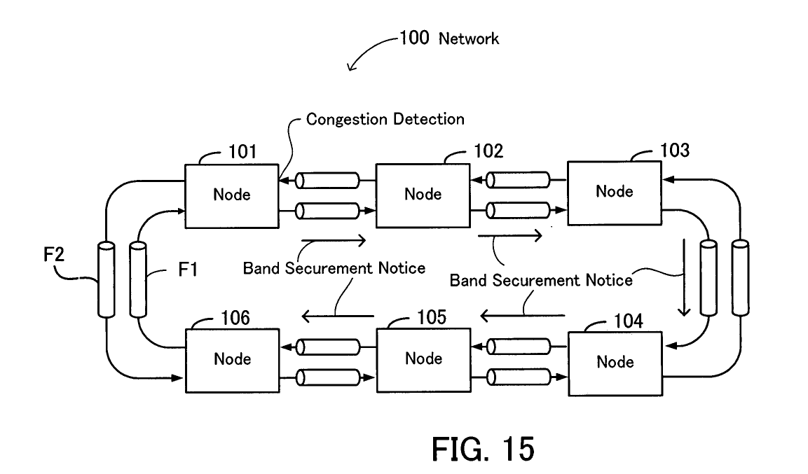

FIG. 16 is a view showing a state of a network in which load is focused on a specific node;

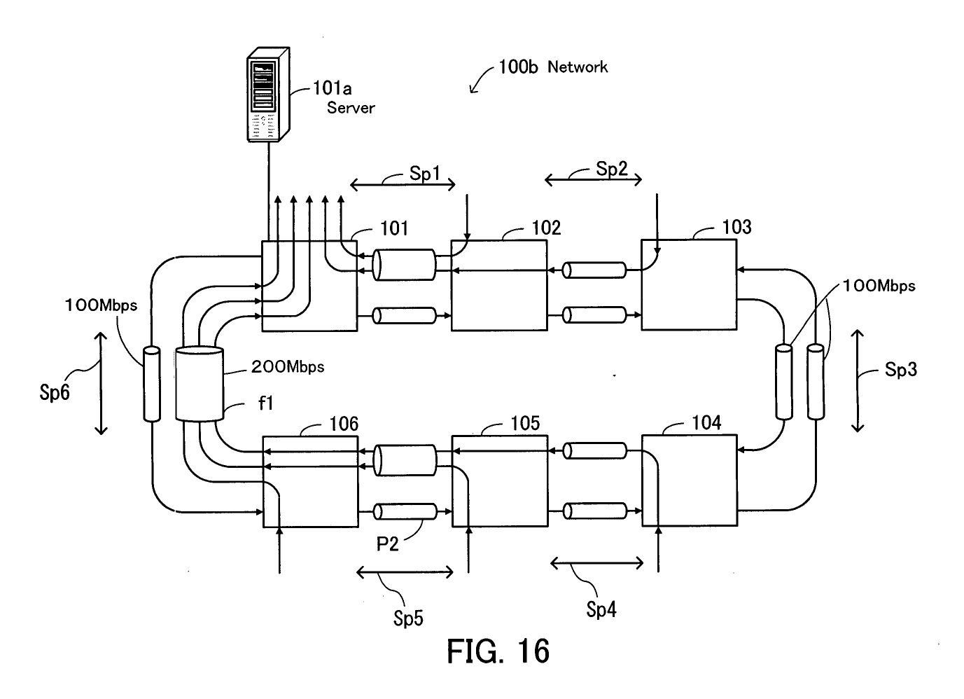

FIG. 17 shows a state of a network in which a Wrapping is executed; and

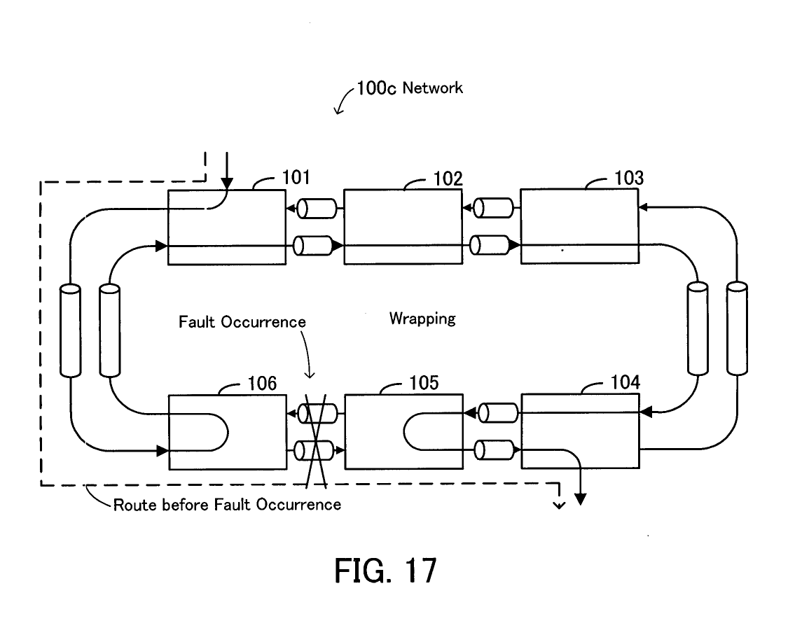

FIG. 18 shows a state of a network in which a Steering is executed.

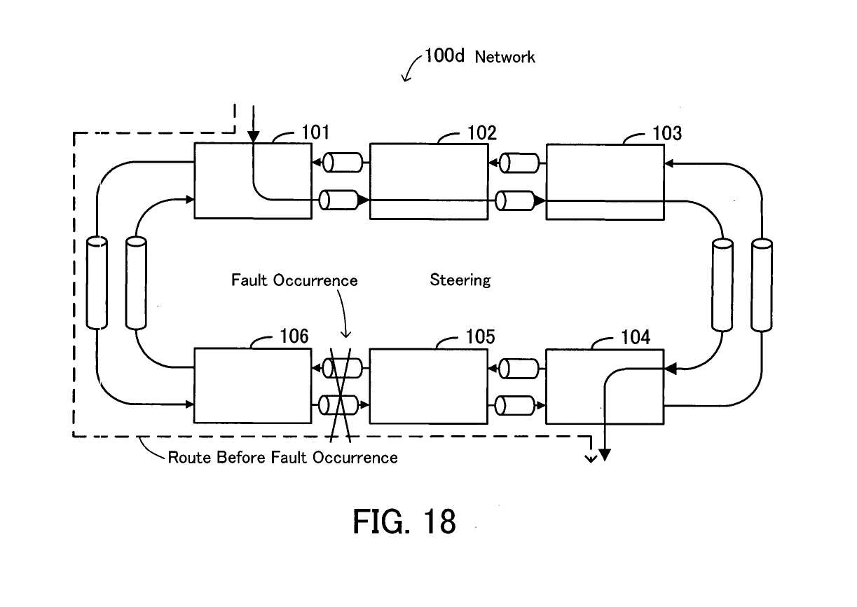

### DESCRIPTION OF THE PREFERRED EMBODIMENTS

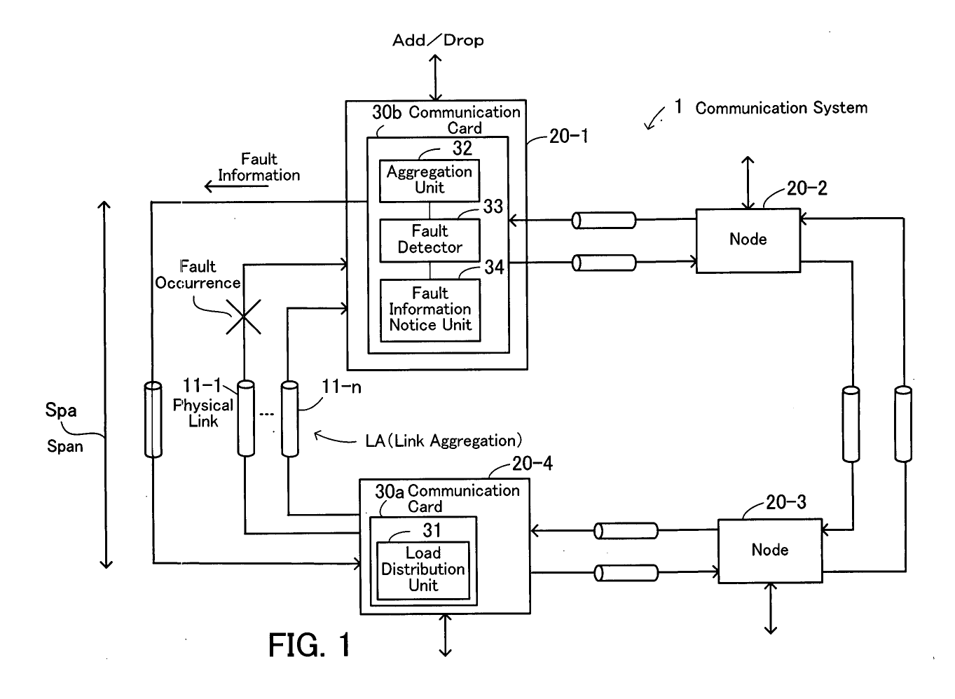

Hereafter, the embodiments of the present invention will be described with reference to the accompanying drawings. FIG. 1 shows a conceptual view of the communication system. In the communication system 1, nodes 20-1 to 20-4 are connected in a ring topology so that a double ring is composed. The double ring consists of a clockwise ring route and a counterclockwise ring route. The information added to the nodes 20-1 to 20-4 are transferred into the nodes 20-1 to 20-4 to which the information is to be dropped.

A plurality of physical links (optical fibers) 11-1 to 11-n are installed in a span Spa of the network where a transmission band is locally increased. Those physical links enable to accommodate the increased transmission band. For example, if the increase of the transmission band results in expanding the capacity of one optical fiber into 30 Gbps though the optical fiber originally has a capacity of 10 Gbps, three optical fibers are required to be installed. In this embodiment, a span Spa between the nodes 20-1 and 20-4 is arranged to have a plurality of physical links on the clockwise route (directed from the node 20-4 to the node 20-1).

A communication node 30a is mounted to the node on the transmitting side of the span Spa, that is, the node 20-4 at the preceding stage to a plurality of physical links. The communication node 30a includes a load distribution unit 31. The load distribution unit 31 aggregates the plurality of physical links 11-1 to 11-n as a link aggregation (referred simply to as the LA) and distributes the load into the physical links 1-1 to 11-n.

In receipt of fault information notified by the node 20-1 located at a succeeding stage of those physical links (for example, the fault information of the physical link 11-1), the load distribution unit recalculates load to be distributed to the normally communicable physical links (11-2 to 11-n where no fault takes place), for newly distributing the load to those physical links. The LA is a connecting system by which a plurality of physical links are virtually formed as a virtual one link. The LA is prescribed in IEEE.802.3ad.

The other communication card 30b is mounted to the node on the receiving side of the span Spa, that is, the node 20-1 at a succeeding stage of those physical links. The communication card 30b includes an aggregation unit 32, a fault detector 33 and a fault information notice unit 34. The aggregation unit 32 receives and aggregates the data transmitted through those physical links 11-1 to 11-n and then output the data to the proper destinations. (For example, the data is dropped in the node 20-1 and then transferred outside the ring or to the node 20-2.)

The fault detection unit 33 detects one or more faults on one or more of the physical links composing the LA. (In FIG. 1, since a fault occurs on the physical link 11-1, the fault is detected.) Then, the fault detection unit 33 generates fault information that indicates which of the physical links an abnormality occurs when data is received. The fault information notice unit 34 notifies the node 20-4 at the preceding stage of the fault information through the use of the ring route in the opposite direction to the fault-detecting direction, that is, the counterclockwise ring route.

Since the fault information is merely required to be notified to the node of the preceding stage, it is possible to transfer )this fault information through the clockwise ring route in the same direction as the fault-detecting direction, or if a network management system (referred simply to as the NMS) for managing the communication system 1 is installed, it is possible to transfer the fault information through the NMS.

In addition, for the sake of convenience in the explanation, the foregoing network is configured so that the load distribution unit 31 is provided in the communication card 30a on the data transmitting side and the aggregation unit 32, the fault detection unit 33 and the fault information notice unit 34 are provided in the communication card on the data receiving side. Instead, the load distribution unit 31, the aggregation unit 32, the fault detection unit 33 and the fault information notice unit 34 may be provided in one communication card (called the communication card 30).

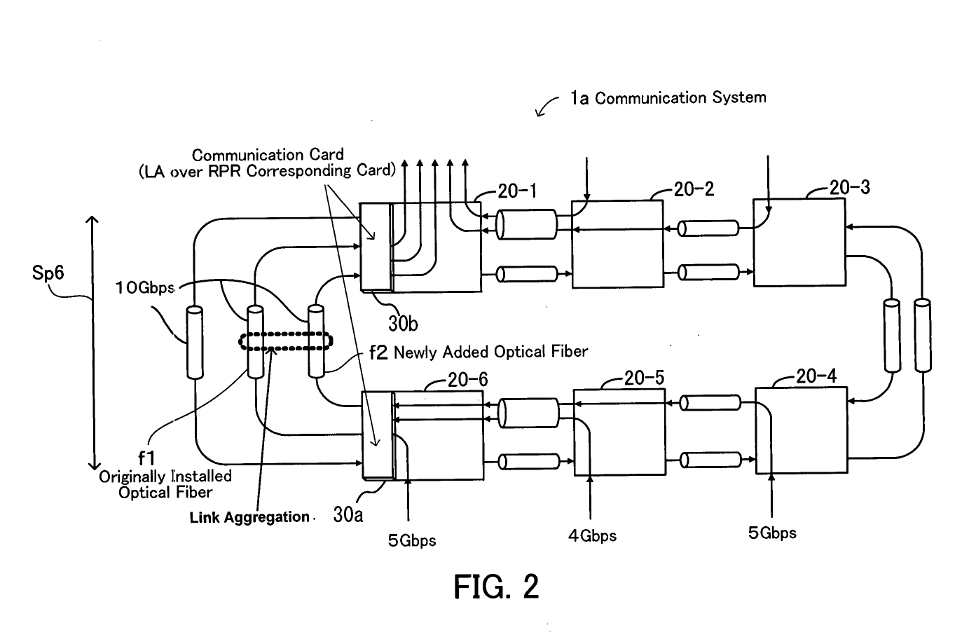

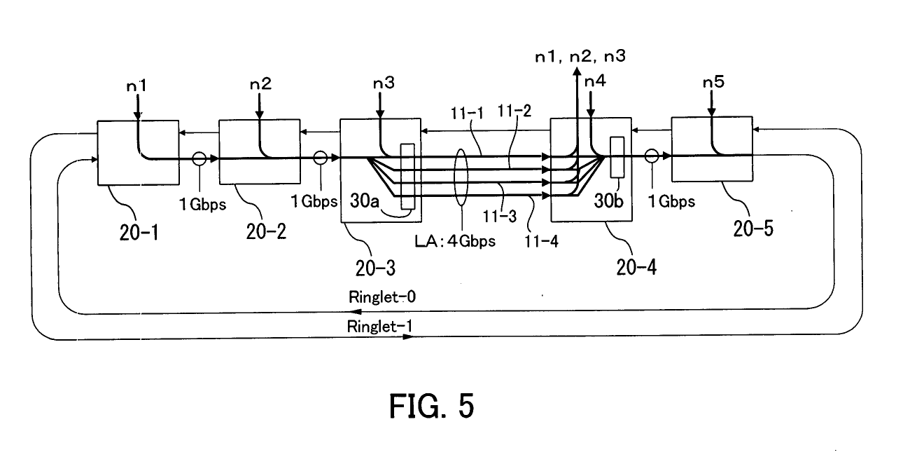

Before describing the protection mechanism of the communication system 1 (which process will be discussed with reference to FIG. 5 or later), the LA configuration corresponding with local increase of a band in the RPR ring network will be described with reference to FIGS. 2 to 4.

FIG. 2 shows the LA configuration corresponding with the local increase of a band on the RPR ring network. The communication system 1a includes the nodes 20-1 to 20-6, which are connected in a double ring. Though not shown, a server for concentratively processing the data is connected with the node 20-1. Hence, the packets added from each of the nodes 20-2 to 20-6 are transferred to the node 20-1.

Herein, it is assumed that the RPR of 10 Gbps is configured. (The packets are transmitted in 10 Gbps clockwise or counterclockwise.) In this RPR, the packets are transmitted in not the band assurance class but the band non-assurance class (for example, class B-EIR, class C) .

Before the description about FIG. 2, the description will be oriented to the difference of the packet transmission between the band assurance class and the band non-assurance class. Assuming that the maximum physical band is 10 Gbps, when the line fault occurs when the packets are transmitted in 10 Gbps clockwise, the ring is switched into the counterclockwise ring. In this case, if the packets are transmitted in 10 Gbps also in the counterclockwise direction, the information of 10 Gbps being transmitted counterclockwise is offset.

Therefore, in the band assurance class, by using a half of the physical band, it is necessary to secure the assurance of the band even if a fault occurs. In this embodiment, in a case that a fault occurs when packets are transmitted in 5 Gbps clockwise and the line is switched into the counterclockwise ring, if the packets are transmitted in 5 Gbps counterclockwise, the information of 10 Gbps on the maximum physical band is allowed to flow counterclockwise. It means that the band is assured. Conversely, in a case that packets are transmitted in the band non-assurance class, the path is allowed to be set to have a maximum physical band. In the band non-assurance class, if the ring switching resulting from the fault as described above is brought about, transmission of those packets in this class is not assured.

In FIG. 2, in clockwise ring route of the span Sp6 between the nodes 20-6 and 20-1 (directed from the nodes 20-6 to 20-1), the path is active in the flow of the nodes 20-4, 20-5 and 20-6 to the node 20-1. In this flow, no problem takes place in the case the total of the path band stays within 10 Gbps. If the other band capacity rather than 10 Gbp is desired, the physical band capacity is short in the clockwise link of the ring route from the nodes 20-6 to 20-1.

For example, in a case that a path of 5 Gbps from the node 20-4 and the path of 4 Gbps from the node 20-5 are set in the clockwise ring route destined for the node 20-1, at this time, the clockwise ring route from the nodes 20-6 to 20-1 occupies a band of 9 Gbps. Hence, when the path of 5 Gbps is tried to be set to the clockwise ring route from the nodes 20-6 to 20-1, the band to which the path may be set clockwise is limited to at maximum 1 Gbps.

Knowing that the efficiency becomes lower, it is possible to set a path destined for the node 20-1 in the counterclockwise direction. Even in this case, if the total band of the counterclockwise path from the nodes 20-3 to 20-1 is 10 Gbps, a limitation takes place in the link between the nodes 20-2 and 20-1, so that no path may be set to the link.

Hence, in the case of increasing the transmission band as described above, in the link of the clockwise ring route from the nodes 20-6 to 20-1, a band capacity is short by 4 Gbps, so that the LA of the link band of 20 Gps may be configured by adding one link of 10 Gbps.

(Configuring Process 1)

The communication card 30a of 10 Gbps is mounted to the node 20-6. The communication card 30b of 10 Gbps is mounted to the node 20-1. The optical fiber of 10 Gbps is additionally connected between the nodes 20-6 and 20-1. Hereafter, the communication card 30 is called an LA over RPR corresponding card 30. An optical fiber f1 is an original fiber and an optical fiber f2 is a newly added fiber.

(Configuring Process 2)

The LA function is made valid in the nodes 20-6 and 20-1. This makes it possible to distribute the load by performing the LA hash operation with respect to the existing path (directed from the nodes 20-4 and 20-5 to 20-1). (The load is evenly distributed to the optical fibers f1 and f2.)

(Configuring Process 3)

The process is executed to, in the node 20-6, recalculate the FairRate of the using band of the link in the clockwise ring route directed from the node 20-6 to the node 20-1, recognize that the effective band has a capability of 11 Gbps (=20 Gbps−(4 Gbps set as a path in the node 20-4)−(5 Gbps set as a path in the node 20-5), and notify the recalculated FairRate to the source nodes (20-4 and 20-5). (When the optical fiber f2 is added and thereby the LA function is executed, the FairRate is recalculated in the node 20-6 and then notified to the nodes 20-4 and 20-5. In response to the notice, the nodes 20-4 and 20-5 recognize that the paths of 5 Gbps and 4 Gbps may be set thereto.)

(Configuring Process 4)

A path of 5 Gbps is set between the nodes 20-6 and 20-1. As a result, the path band of 15 Gbps is transmitted in the clockwise ring route of the LA link directed from the nodes 20-6 to 20-1.

Though the path band directed from the nodes 20-6 to 20-1 may be increased in the foregoing configuring process, for increasing the path band directed from the nodes 20-4 and 20-5 to the node 20-1, the band capacity may be short between the nodes 20-5 and 20-6. However, since the LA link configuration may correspond with the local increase of the band, the band capacity may be increased also in the route from the nodes 20-5 to 20-6.

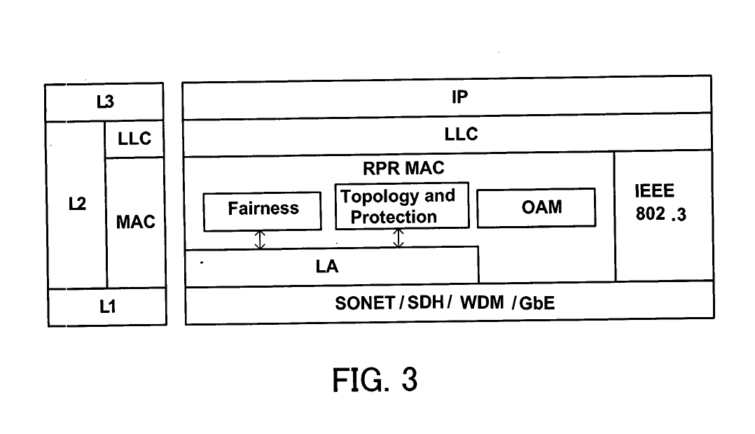

In turn, the description will be oriented to the protocol stack. FIG. 3 shows a protocol stack. The RPR MAC, that is, the protocol for realizing the communication system 1 is located in a MAC sublayer of the layer 2 (L2).

In the layer 1 (L1) is located the SONET/SDH, WDM and GbE, for example. The Ethernet of IEEE802.3 is located in the MAC sublayer. In the RPR MAC of the MAC sublayer is located the LA. In a higher order of the LA is located the Fairness, the Topology and Protection dedicated for the ring topology of the RPR and the fault proteciton thereof, and further the OAM (Operation And Maintenance). In a higher order of the MAC sublayer is located an LLC (Logical Link Control) sublayer. The layer 3 (L3) corresponds to the IP (Internet Protocol).

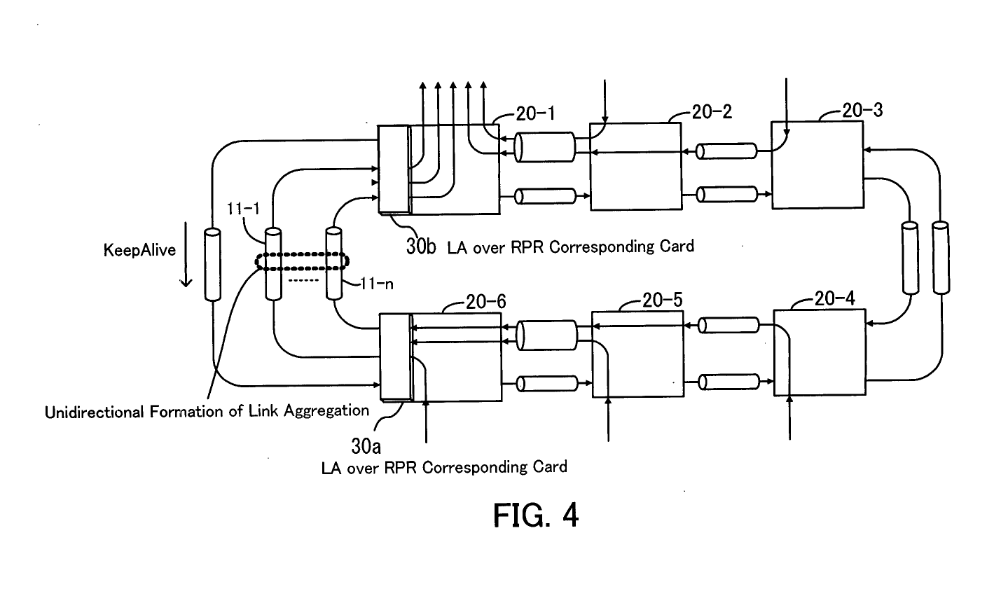

In turn, the description will be oriented to the LA configuration in a unidirectional ring route. FIG. 4 shows the LA configuration in a unidirectional ring route. The network configuration is the same as that shown in FIG. 2.

The LA over RPR corresponding card 30b operates to transmit to the LA over RPR corresponding card 30a a connecting state notice for noticing the connecting states of the physical links 11-1 to 11-n through the counterclockwise ring route. Actually, as this notice for the connecting state may be used KeepAlive packets, (which are periodically transmitted for making sure that the connection is effective).

The load distribution unit 31 provided in the LA over RPR corresponding card 30a controls the distribution of load for the plurality of physical links 11-1 to 11-n formed on the clockwise ring route based on the connecting state notice.

As described above, by communicating a network state between the nodes and constantly transferring an assurance for normality therebetween, it is possible to generate the LA in the unidirectional ring route in the span of the ring network in which span the transmission band capacity is locally increased (that is, to increase or decrease the physical link). (That is, when configuring the LA, the LA may be configured in one of the clockwise and the counterclockwise routes and is not required to be configured in both of the routes.) Further, the minimum facility may be necessary when load is concentrated on a specific node and the dynamic connecting capacity is required.

In turn, the description will be oriented to the application of the protection mechanism (referred to as the LA protection) of the communication system 1 on the RPR network.

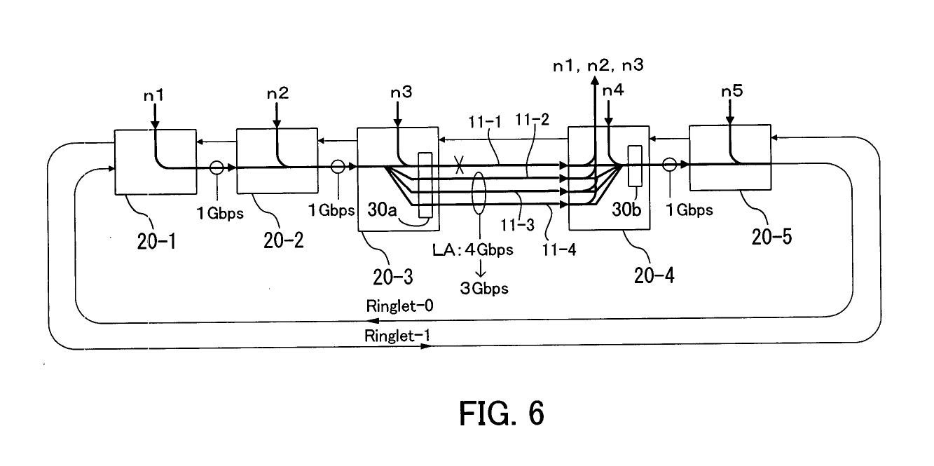

FIGS. 5 and 6 show the operating states of the LA protection. In these figures, the nodes 20-1 to 20-5 are connected in a ring topology. The clockwise ring route includes the nodes 20-1, 20-2, 20-3, 20-4, 20-5 and 20-6 connected in that order. Then, the ring returns around to the node 20-1. The data n1 to n5 are respectively added to the nodes 20-1 to 20-5 and are flown clockwise. The data n1 to n3 are dropped in the node 20-4.

Further, it is assumed that as a ring transmission band, the RPR network of one Gbps is configured and the data is transmitted in the band assurance class (such as class A or classB-CIR). Further, the LA consisting of four physical links 11-1 to 11-4 (each of which has a capacity of 1 Gbps and thus by which the data of 4 Gbps can be transmitted at maximum)is configured. The node 20-3 corresponds to the node at the preceding stage to those physical links and the node 20-4 corresponds to the node at the succeeding stage than those physical links.

In FIG. 5, in the band assurance class of the RPR, as stated above, the upper limit of the path to be set is limited to a half of a physical band included in one ring has a capacity of 1 Gbps, the upper limit is 500 Mbps. (Concretely, the upper limit of the data transmission band is 500 Mbps in the clockwise or the counterclockwise ring route.) Hence, even the LA composed of the physical links 11-1 to 11-4 makes the transmission of 500 Mbps possible at maximum as the band assurance class. (The total capacity of the band of the route directed from the nodes 20-1, 20-2 and 20-3 to 20-4 reaches 500 Mbps.)

The load distribution unit 31 included in the LA over RPR corresponding card 30a operates to distribute the data of totally 500 Mbps in the band assurance class into the physical links 11-1 to 11-4 when the data is outputted. The aggregation unit 32 included in the LA over RPR corresponding card 30b operates to aggregate the data transmitted from the physical links 11-1 to 11-4.

In FIG. 6, assume that a fault occurs in the physical link 11-1. At first, the fault detector 33, included in the card 30b in the node 20-4 at the succeeding stage of the link 11-1, detects a disconnection of the link, recognizes that the remaining link bands cover the transmission of the band assurance class, and starts the LA protection.

Then, through the fault information to be transmitted from the node 20-4 at the succeeding stage to the node 20-3 at the preceding stage through the counterclockwise ring route, the information for specifying the disconnected link is notified. The fault information is detected by the LA over RPR corresponding card 30a located in the node 20-3 at the preceding stage. It is recognized by the fault information that a fault occurs in the link 11-1 among those physical links. In addition, the fault information may be notified by using the KeepAlive.

The load distribution unit 31 located in the node 20-3 at the preceding stage recognizes the number of the load distributed destinations is reduced from four to three. Then, the load distribution unit 31 newly calculates the load to be distributed so that the data of totally 500 Mbps may be sent out through the remaining three physical links 11-2 to 11-4 and then outputs the data.

As described above, when the data of the band assurance class is transmitted through the LA link, if a fault occurs in one of the physical links composing the LA, basically, the foregoing LA protection is executed if at least one physical link is left. This is because the transmission band of one physical link corresponds to the physical band of the ring. Further, if faults occur in all the physical links composing the LA, the existing protection for the RPR such as the Wrapping or the Steering is carried out.

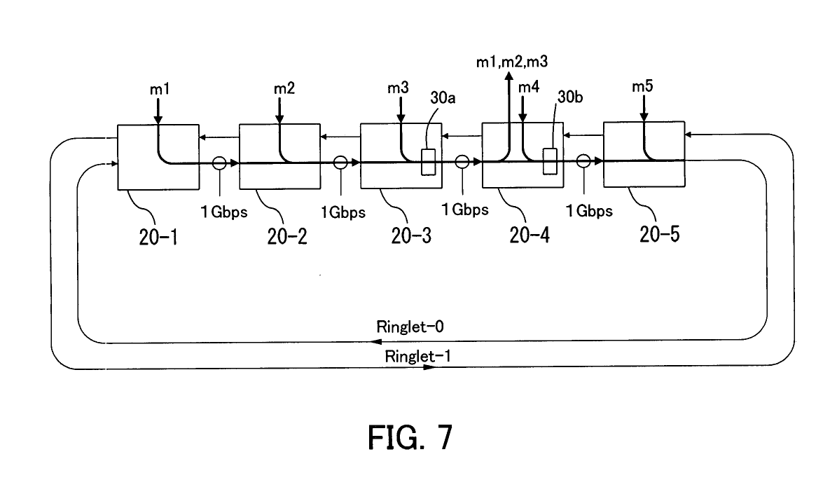

FIGS. 7 to 9 show the operating state of the LA protection. The nodes 20-1 to 20-5 are connected in a ring manner so that those nodes may form a clockwise ring route in the describing sequence. The data m1 to m5 are respectively added to the nodes 20-1 to 20-5 and are caused to flow clockwise. The data m1 to m3 are dropped in the node 20-4. Further, in this operating state, the RPR network with the ring transmission band of 1 Gbps is configured and the data is transmitted in the band non-assurance class (such as classB-EIR or classC).

In FIG. 7, it is assumed that the increase of a transmission capacity of the corresponding paths with the data m1 to m3 leads to the local increase of the band in the clockwise link between the nodes 20-3 and 20-4. That is, assuming that the transmission bands of the corresponding paths with the data m1 to m3 are M1 to M3 and the transmission band to be secured by the clockwise link between the nodes 20-3 and 20-4 is Link Rate, the relation of (M1+M2+M3)>LinkRate is established.

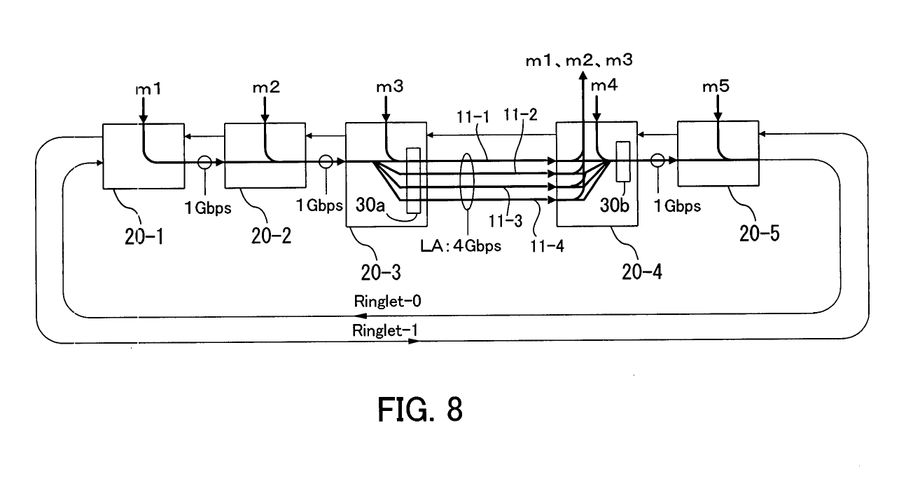

In FIG. 8, four physical links 11-1 to 11-4 each having a capacity of 1 Gbps are formed as clockwise ring route between the nodes 20-3 and 20-4. (Three physical links each having a capacity of 1 Gbps are added.)

Assuming that the total band (M1+M2) of the paths directed from the nodes 20-1 and 20-2 to the node 20-4 stays within 1 Gbps, the LA link of 4 Gbps is configured in the path band (M3) directed from the nodes 20-3 to 20-4. If all the links are in the band non-assurance class, the LA link may use the band of up to 3

Herein, it is assumed that M1=0.5 Gbps, M2=0.5 Gbps, and M3=3 Gbps. (This setting may be realized by weighting the path directed from the nodes 20-3 to 20-4 more than the other path (called the “unequal weighted shaper” in the Fairness algorithm.) Further, the load distribution unit 31 located in the LA over RPR corresponding card 30a of the node 20-3 distributes the load of the totally 4 Gbps data into the physical links 11-1 to 11-4 when it outputs the data. The aggregation unit 32 of the node 20-4 aggregates the data transmitted from the physical links 11-1 to 11-4. In this state, (M1+M2+M3)<Link Rate is established.

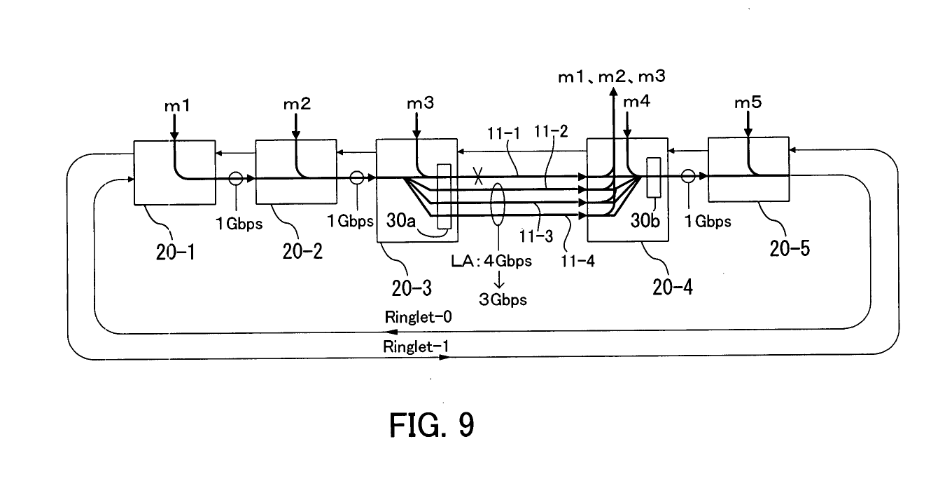

FIG. 9 is an explanatory view showing the state where a fault occurs in the physical link 11-1 in the configuration shown in FIG. 8. When a fault occurs in the physical link 11-1, the allowable transmission band in the LA is 3 Gbps. The node 20-3 performs a process of recalculating the fairRate of the link between the nodes 20-3 and 20-4, for executing a process of redistributing the band about the source nodes (nodes 20-1 to 20-3) in the band distribution of the clockwise ring route between the nodes 20-3 and 20-4.

Herein, assuming that M3 is set to be six times as large as (3 Gbps shaper) the weight of the M1 or M2 (each of which is 0.5 Gbps shaper in this embodiment), a weight ratio is M1:M2:M3=1:1:6. Hence, M1:M2:M3=0.375 Gbps: 0.375 Gbps: 2.25 Gbps is established.

As a result, the link of the clockwise ring route between the nodes 20-3 and 20-4 uses the full band of the three normal physical links, that is, 3 Gbps. Hence, the fairRate notice to be given from the node 20-3 to the node in the upstream (node in the counterclockwise direction) becomes 0.375 Gbps. The nodes 20-1 and 20-2 receive the fairRate notice of the band redistribution and changes each band from 0.5 Gbps, which is the band before the fault occurrence, to 0.375 Gbps.

As described above, when the data of the band non-assurance class is transmitted through the LA link, if a fault occurs in one or more of the physical links composing the LA, basically, the foregoing LA protection is executed if at least one physical link is left with no fault. Hence, for each fault, the band redistribution is executed on the fairRate-recalculated result. Further, if faults occur in all the physical links composing the LA, the existing protection mechanism such as the Wrapping or the Steering is executed.

In turn, the description will be oriented to the LA over RPR card 30.

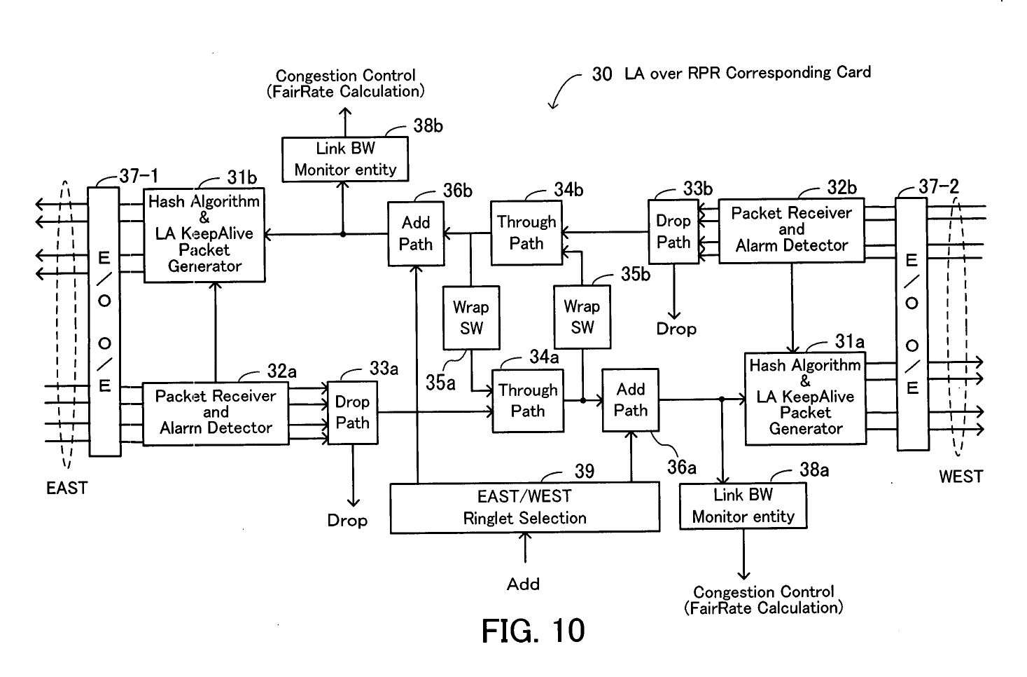

FIG. 10 shows the functional arrangement of the LA over RPR corresponding card 30. The card 30 includes Hash Algorithm & LA KeepAlive Packet Generators 31a, 31b, Packet receivers and Alarm detectors 32a, 32b, Drop Paths 33a, 33b, Through Paths 34a, 34b, Wrap SWs 35a, 35b, Add Paths 36a, 36b, an E/O O/E 37-1 connected with the EAST side transmission path, an E/O O/E 37-2 connected with the WEST side transmission path, Link BW (Band Width) Monitor entities 38a, 38b, and an EAST/WEST Ringlet Selection 39.

The E/O O/Es 37-1, 37-2 operate to convert a light signal transmitted from another node into an electric signal or convert an electric signal processed by its node into an optical signal and then output the converted signal. The Hash Algorithm & LA KeepAlive Packet Generators 31a, 31b have a function of the load distribution unit 31. These generators 31a, 31b perform a harsh operation with respect to the packets to be transferred so that the load may be evenly allocated. Based on the harsh operation, the physical links to which the packets are to be sent are determined for distributing the load. In this case, if the alarm information is received from the Packet receivers and Alarm detectors 32a, 32b, the harsh operation is recalculated so that the packets may be sent to only the normally operated physical links, for distributing the load. In addition, the generators 31a, 31b have a function of sending and receiving the KeepAlive packets.

The Packet receivers and Alarm detectors 32a, 32b have a function of the aggregation unit 32. Further, the Packet receivers and Alarm detectors 32a, 32b operate to detect a line fault alarm and notice the alarm information to the Hash Algorithm & LA KeepAlive Packet Generators 31a,

The Drop Paths 33a and 33b select a path to be dropped from the received packets. The Drop Paths 33a and 33b then drop the selected path onto the side of the tributary station and transmits the other packets to the Through Paths 34a and 34b respectively.

The Through Paths 34a and 34b transmit the received packets to the Add Paths 36a and 36b respectively. The Wrap SW 35a transmits the packets flown from the WEST to the Through Path 34a. That is, the Wrap SW 35a turns back the packets flowing on the counterclockwise ring route to the clockwise ring route so that those packets may be outputted from the WEST. In the fault protection, the Wrap SW 35b transmits the packets flown from the EAST to the Through Path 34b. That is, the Wrap SW 35b turns back the packets flowing on the clockwise ring route onto the counterclockwise ring route so that those packets may be outputted from the EAST.

The Add Path 36a adds the packets destined for the WEST Ringlet transmitted from the EAST/WEST Ringlet Selection 39 to the packets transmitted from the Through Path 34a and then transmits the added packets to the Hash Algorithm & LA KeepAlive Packet generator 31a and the Link BW Monitor entity 38a.

The Add Path 36b adds the packets destined for the EAST Ringlet transmitted from the EAST/WEST Ringlet Selection 39 to the packets transmitted from the Through Path 34b and then transmits the added packets to the Hash Algorithm & LA KeepAlive Packet generator 31b and the Link BW Monitor entity 38b.

The Link BW Monitor entities 38a and 38b monitor the transmission bands of the packets destined for the WEST Ringlet and the packets destined for the EAST Ringlet and then notifies the Congestion Control unit (not shown) located in the node of the monitored results. (The monitored results are used for calculating the fairRate.)

The EAST/WEST Ringlet Selection 39 selects if the packets added from the side of the tributary station is added (sent out) to the path for the EAST or the path for the WEST. Based on the selected result, the Selection 39 transmits the packets to any one of the Add Paths 36a and 36b.

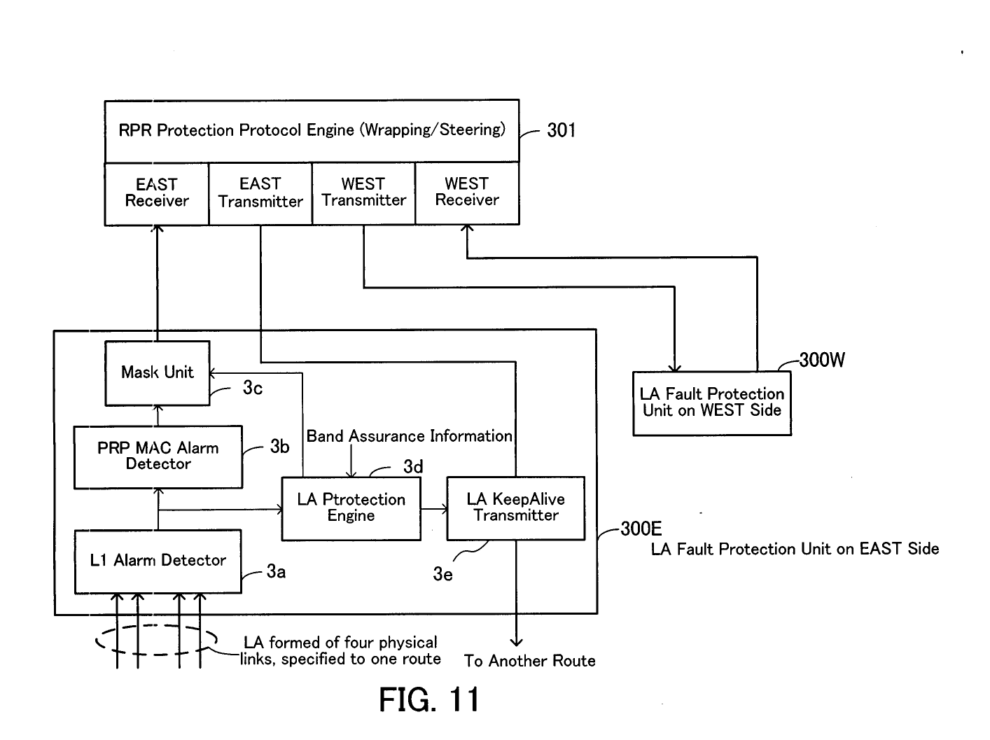

FIG. 11 shows the operation of the LA protection to be executed by the LA over RPR corresponding card 30. An LA fault protection unit on the EAST side 300E is served as both the Hash Algorithm & LA KeepAlive Packet generator 31b and the packet receiver and Alarm detector 32a. An LA fault protection unit on the WEST side 300W is served as both the Hash Algorithm & LA KeepAlive Packet generator 31a and the packet receiver and Alarm detector 32b. The LA fault protection units 300E and 300W have the same function and operation. Hence, the description will be oriented to the LA fault protection unit on the EAST side 300E.

The LA fault protection unit 300E is composed of an L1 alarm detector 3a, a RPR MAC alarm detector 3b, a mask unit 3c, an LA protection engine 3d, and an LA KeepAlive transmitter 3e. The LA alarm detector 3a receives a signal from the EAST side and detects an alarm in the physical layer. As an alarm in the physical layer, an LOS (Loss of Signal) or an SF (Signal Failure) may be referred about the SONET/SDH, and the LOS, an L. D. (Link Down), a C. V. (Code Violation) may be referred about the GbE.

The RPR MAC alarm detector 3b detects an alarm in the RPR MAC layer. As an alarm in the RPR MAC layer, a RPR KeepAlive Failure or a RPR Ringlet Identifier Mismatch may be referred.

The mask unit 3c performs the masking process with respect to the alarm information so as not to start the RPR protection protocol (Wrapping/Steering) in response to the masking instruction sent from the LA protection engine 3d. That is, if the fault may be repaired, the mask unit 3c masks the alarm notice to the upward control unit so as to inhibit the protection for the RPR such as the Wrapping/Steering). If the fault protection is executed by the Wrapping/Steering, the mask unit 3c releases the masks and then notifies the upward RPR protection protocol engine 301 of the alarm information. (Since an alarm is detected from the EAST side, the alarm is notified to the EAST receiving side of the RPR protection protocol engine 301.)

The LA protection engine 3d is inputted with alarms of the physical links composing the LA and terminates the LA KeepAlive packets. Then, the engine 3d determines whether or not the assurance band information may be kept.

The LA protection engine 3d is inputted with the assurance band information and the fault information of the LA link. If it is determined that such a fault as breaking the assurance band takes place, the engine 3d controls the mask unit 3c so that the mask unit 3c releases the mask of the alarm notice to the RPR protection protocol engine 301, and then starts the RPR protection trigger.

Further, in a case that a line fault occurs in the physical link, if the LA protection engine 3d recognizes that the assurance band is kept despite of the fault, the LA protection engine 3d controls the mask unit 3c so that the mask unit 3c masks the alarm notice to the RPR protection protocol engine 301 and notifies the LA KeepAlive transmitter 3e of the port number information of the fault line. In response, the LA KeepAlive transmitter 3e conveys the fault information to a transmitting source node.

In a case that the RPR protection protocol engine 301 executes the fault protection by the Wrapping/Steering, the LA KeepAlive transmitter 3e receives the information about the fault protection from the EAST transmitter of the protocol engine 301 and then conveys the LA keepAlive packets to the transmitting source node.

On the preceding node in which the fault-caused line is used as a transmitting physical link, when the node receives the LA KeepAlive packets having the LA fault information, the node recognizes the fault-caused line and exclusive the fault-caused line from the effective lines through the LA Hash Algorithm. As a result, the traffics are transmitted through only the remaining effective LA lines.

As set forth above, the communication system and the communication method according to the present invention are arranged to mount the LA over RPR corresponding card 30 onto both of the nodes of the link for increasing the transmission band of the link. If a fault occurs in one or more of the physical links composing the LA, those communication system and method are capable of protecting the traffics with a simple LA protection without having to start the RPR protection protocol (Wrapping/Steering) depending on the band, that is, one or more bands of the band assurance class or one or more bands of the physical links composing the LA.

The communication system according to the present invention is arranged to form the plurality of physical links installed in the local span of the network as the link aggregation, detect a fault on one or more of the at the preceding stage, and cause the node at the preceding stage to recalculate the load distribution to the normally communicable physical links. This arrangement makes it possible to execute the process of distributing the load. This allows the protection to the fault occurring on the ring aggregation to be simply executed between the nodes, thereby being able to enhance the efficiency of the network operation.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication system for communicating data on a network, comprising:
a plurality of physical links installed in a local span of said network;
a first node having a first communication card mounted therein, said first communication card having a load distribution unit arranged to virtually form a link aggregation of said plurality of physical links as a virtual link, distribute load to said link aggregation and output data, and, if fault information notified from a node at a succeeding stage is received, recalculate distribution of said load to normally communicable physical links; and
a second node having a second communication card mounted therein, said second communication card having an aggregation unit for aggregating data sent through said plurality of physical links and outputting said data according to their destinations, a fault detector for detecting a fault on said physical links forming said link aggregation and generating said fault information based on said detected fault if any, and a fault information notice unit for noticing said fault information to a node at the preceding stage.

2. The communication system according to claim 1, wherein said first communication card further includes a band redistribution instructing unit, said instructing unit prompting a source node being transmitting data to said link aggregation to redistribute a band if a fault occurs on one or more of said physical links forming said link aggregation and said first communication card receives said fault information.

3. A communication card for communicating data on a network, comprising:
a load distribution unit for virtually forming a plurality of physical links installed in a local span as a link aggregation, distributing load to said physical links, and if fault information notified from a node at a succeeding stage is received, recalculate distribution of said load to normally communicable physical links;
an aggregation unit for aggregating data transmitted through said plurality of physical links and outputting said data according to their destinations;
a fault detector for detecting a fault on one or more of said physical links forming said link aggregation and generating said fault information; and
a fault information notice unit for noticing said fault information to a node at the preceding stage.

4. The communication card according to claim 3, further comprising a band redistribution instructing unit for prompting a source node being transmitting data to said link aggregation to redistribute a band if a fault occurs on one or more of said physical links forming said link aggregation and said fault information is received.

5. A communication method for communicating data on a ring network redundantly configured as a RPR (Resilient Packet Ring), comprising the steps of:
installing a plurality of physical links in a local span of said network;
mounting a first communication card in a node on the side of data transmission, said first communication card being served to execute a load distribution process to a link aggregation virtually formed of a plurality of physical links, and outputting load data to said link aggregation, and if fault information notified from a node at a succeeding stage is received, recalculating distribution of said load to normally communicable physical links;
mounting a second communication card in a node on the data receiving side, said second communication card serving to aggregate data transmitted through said plurality of physical links, output said data according to their destinations, if a fault is detected on one or more of said physical links forming said link aggregation, generate said fault information, and notify said fault information of a node at the preceding stage; and
protecting said fault only between said nodes included in said link aggregation without having to start a fault protection protocol included in a RPR protocol if a fault occurs on one or more of said physical links forming said link aggregation.

6. The communication method according to claim 5, wherein if a fault occurs on one or more of said physical links forming said link aggregation and said fault information is received, said first communication card operates to prompt a source node being transmitting data to said link aggregation to redistribute a band.
